(19) United States
(12) Patent Application Publication
(10) Pub. No.: US 2007/0269300 A1
(43) Pub. Date: Nov. 22, 2007

(54) VARIABLE SPEED MOTOR DRIVEN HAND TRUCK

(76) Inventor: Larry Menard, Manhattan, KS (US)

Correspondence Address: HOVEY WILLIAMS LLP, 2405 GRAND BLVD., SUITE 400, KANSAS CITY, MO, 64108, US

(21) Appl. No.: 11/746,362

(22) Filed: May 9, 2007

Related U.S. Application Data
(60) Provisional application No. 60/747,488, filed on May 17, 2006.

(51) Int. Cl. B62B 1/06

(52) U.S. Cl. 414/444

(57) ABSTRACT

A powered hand truck particularly suited for transporting heavy loads over uneven terrain is provided. The hand truck generally comprises a load-bearing assembly and a rear drive assembly is provided. The load-bearing assembly comprises a load-bearing frame and a forward axle presenting a pair of forward wheels. The drive assembly comprises a motor assembly presenting a rear axle presenting a pair of rear wheels. The load-bearing assembly is coupled to the drive motor assembly via a steering frame that permits pivoting of the motor assembly and load-bearing frame relative to each other about two different axes.

### RELATED APPLICATION

The present application claims the benefit of U.S. Provisional Application Ser. No. 60/747,488, filed May 17, 2006, incorporated by reference herein.

### BACKGROUND OF THE INVENTION

1. Field of the Invention

The present invention is generally directed toward a powered hand-truck that maybe used to transport heavy objects. More specifically, the powered hand-truck includes a load-bearing assembly onto which the object may be loaded and a drive assembly that comprises a motor for propelling the load-bearing assembly.

2. Description of the Prior Art

One of the most common causes of workplace injuries is overexertion, particularly in the lifting and handling of heavy objects. Despite efforts by companies to train employees on proper lift and handling procedures, overexertion continues to be a growing problem. Hand trucks, or dollies, are useful tools to assist workers in the transport of heavy objects. However, traditional hand trucks are manually propelled and require significant efforts on behalf of the operator to steady the load and push the truck including the object to the desired location. Thus, the risk of injury when transporting heavy objects is significant even when using such a hand truck.

Powered or self-propelled devices have been constructed to assist workers with the transport of cumbersome or heavy items. Such devices often require the user to physically ride onboard the device during operation thereof rather than simply walk behind. Other motorized devices have been developed for use on relatively flat, smooth surfaces. Such devices may become unstable, and therefore unsafe, if used to transport objects over rough terrain. Other previous powered, transport devices comprise complex mechanical systems making the devices not only difficult to operate, but expensive to maintain.

Therefore, there is a need in the art for an easy-to-use device that will help decrease workplace injuries caused by overexertion and to significantly reduce the effort required to transport heavy loads over rough or uneven terrain. Further, the device ought to provide improved stability when transporting heavy loads over difficult terrain.

### SUMMARY OF THE INVENTION

The present invention overcomes the above problems by providing, in one embodiment, a motorized hand truck comprising a load-bearing assembly and a drive assembly. The load-bearing assembly includes a load-bearing frame and a forward axle coupled to the load-bearing frame presenting a pair of forward wheels. The forward wheels are attached to opposite ends of the forward axle. The a drive assembly includes a motor assembly coupled to a rear axle. The rear axle presents a pair of drive wheels which are attached to opposite ends of the rear axle. The drive assembly also includes a steering frame that is pivotally coupled to the motor assembly and pivots relative to the motor assembly about a generally upright axis. The steering frame is also pivotally coupled to the load-bearing assembly, which pivots relative to the steering frame about a generally horizontal axis.

In another embodiment, the present invention is directed toward a motorized hand truck comprising a load-bearing assembly and a drive assembly. The load-bearing assembly includes a load-bearing frame comprising at least one user handle presenting a switch for controlling the operation of the hand truck, a locking aim, and a forward axle coupled to the load-bearing frame presenting a pair of forward wheels. The drive assembly includes an electric motor assembly coupled to a rear axle. The rear axle presents a pair of drive wheels. The operation of the motor assembly is controlled by the switch. The drive assembly also comprises a steering frame that is pivotally coupled to the motor assembly via a rear pivot joint and to the load-bearing assembly via a pair of forward pivot joints. The locking arm is configured for releasable engagement with a locking pin. The load-bearing frame is shiftable between an upright position and a reclined position relative to the drive assembly. The locking arm and the locking pin cooperate to lock the load-bearing frame in the reclined position.

### BRIEF DESCRIPTION OF THE DRAWINGS

FIG. 1 is an isometric view of a motor-driven hand truck in accordance with the present invention;

FIG. 2 is a side view of the hand truck of FIG. 1 shown in the reclined position;

FIG. 3a is a close-up view of the motor assembly and latching mechanism of the hand truck in the locked configuration;

FIG. 3b is a close-up view of the motor assembly and latching mechanism in the unlocked configuration;

FIG. 4 is a side view of the hand truck in the upright position;

FIG. 5 is an assembly view of the latching mechanism;

FIG. 6a is a top view of the motor assembly and steering frame of the hand truck; and

FIG. 6b is a top view of the motor assembly and steering frame showing the range of pivot of the steering frame.

### DETAILED DESCRIPTION OF THE PREFERRED EMBODIMENT

The following description pertains to a powered hand truck in accordance with the present invention. It is to be understood, however, that this description is provided by way of illustration and nothing therein should be taken as a limitation upon the overall scope of the invention.

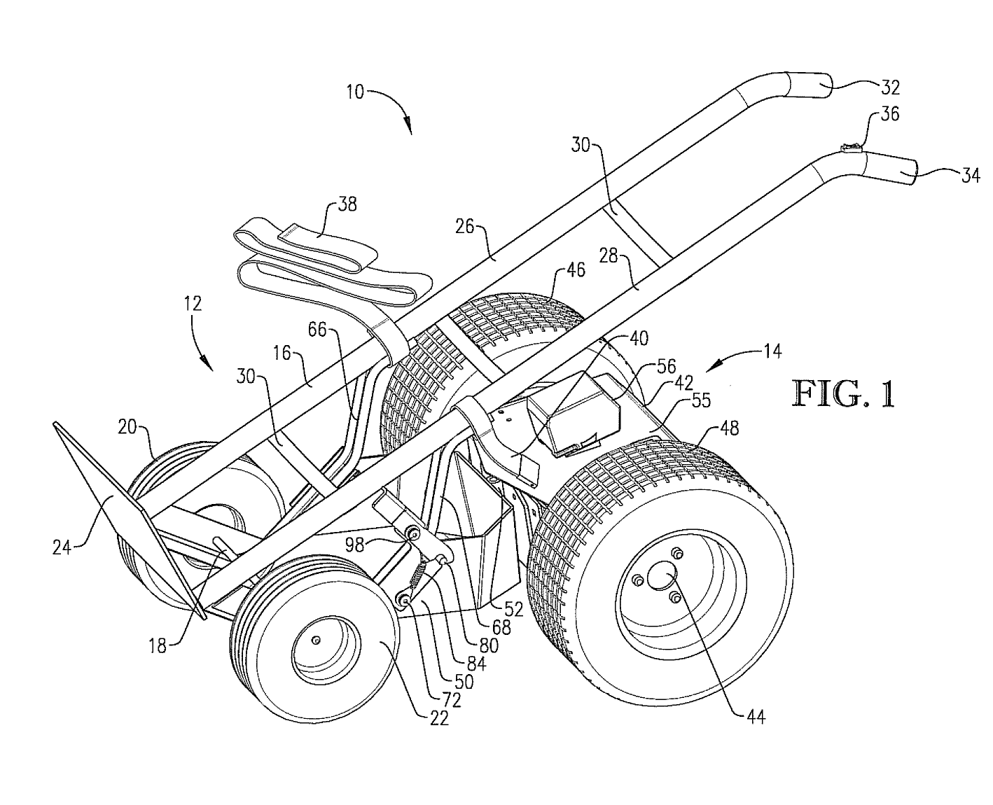

Turning now to FIG. 1, a motorized hand truck 10 is provided comprising a load-bearing assembly 12 and a drive assembly 14. Load-bearing assembly 12 comprises a load-bearing frame 16 and a forward axle 18 presenting a pair of forward wheels 20, 22. In one embodiment, wheels 20, 22 comprise eight-inch pneumatic tube tires, although it is within the scope of the invention for other sizes of tires and wheels to be employed. Forward wheels 20, 22 are shown attached to opposite ends of forward axle 18. In certain embodiments, load-bearing assembly 12 is configured like a conventional, non-powered dolly in many respects. For example, assembly 12 includes a load-bearing platform 24 which supports a load being transported by hand truck 10. Assembly 12 also comprises a pair of substantially parallel support members 26, 28 connected by a plurality of cross-braces 30. At the upper ends of members 26, 28, opposite platform 24, are a pair of user handles 32, 34 that are grasped by the operator during use of hand truck 10. At least one of handles 32, 34 includes a switch 36, which, as explained in greater detail below, allows the user to actuate an electric motor carried by drive assembly 14. Straps 38, 40 are provided so that the load carried by hand truck 10 may be secured to load-bearing assembly 12.

Drive assembly 14 generally comprises a motor assembly 42 coupled to a rear axle 44. A pair or drive wheels 46, 48 are attached to opposite ends of rear axle 44. In one embodiment, drive wheels 46, 48 comprise 16-inch, all-terrain, pneumatic tube tires, although it is within the scope of the present invention for other sizes of tires and wheels to be used. In other embodiments, drive wheels 46, 48 present a diameter that is larger than the diameter of forward wheels 20, 22. In still other embodiments, wheels 46, 48 present a diameter that is at least about 25% larger than that of wheels 20, 22, and more particularly about 50% larger.

Assembly 14 also comprises a steering frame 50 that is pivotally coupled to motor assembly 42 via a rear pivot joint 52. Steering frame 50 is free to pivot relative to motor assembly 42 about a generally upright axis. As used herein, the tern “generally upright” should not be taken as equivalent to “vertical” although the term “vertical” is encompassed thereby.

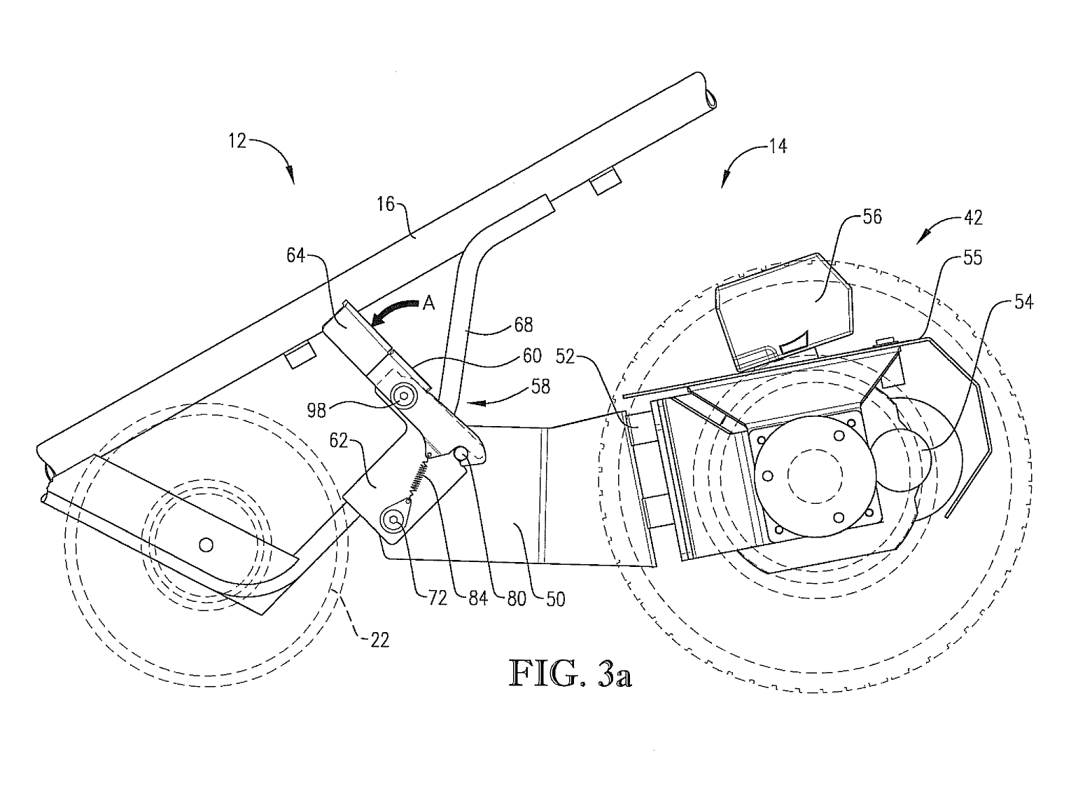

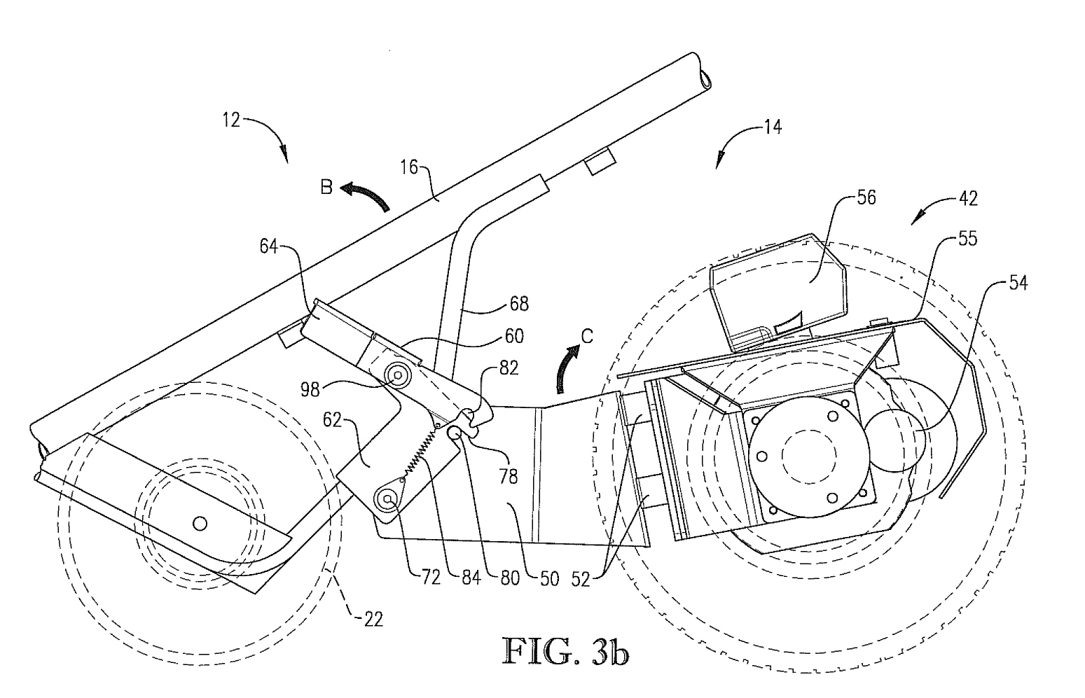

Hand truck 10, as shown in the figures, is provided with an electric motor 54 (see, e.g., FIG. 3a) housed inside an outer covering 55. In certain embodiments, motor 54 has a power output of between about 0.5-5 HP, more particularly between about 1-3 HP, and even more particularly of about 1.5 HP. However, it is within the scope of the present invention for other types of motors to be used, including but not limited to internal combustion engines. Electric motors present certain advantages over internal combustion engines in that they are generally lighter and do not produce noxious exhaust fumes thereby making hand truck 10 suitable for use indoors as well as outdoors. A battery pack 56 is provided as the power source for motor 54. In certain embodiments, battery pack 56 comprises a 28V lithium-ion battery that may be detached and recharged. Other types of batteries, including those having different voltages, may be used. In other embodiments, the battery pack may be carried internally and recharged through a fixed or detachable electrical cord (not shown).

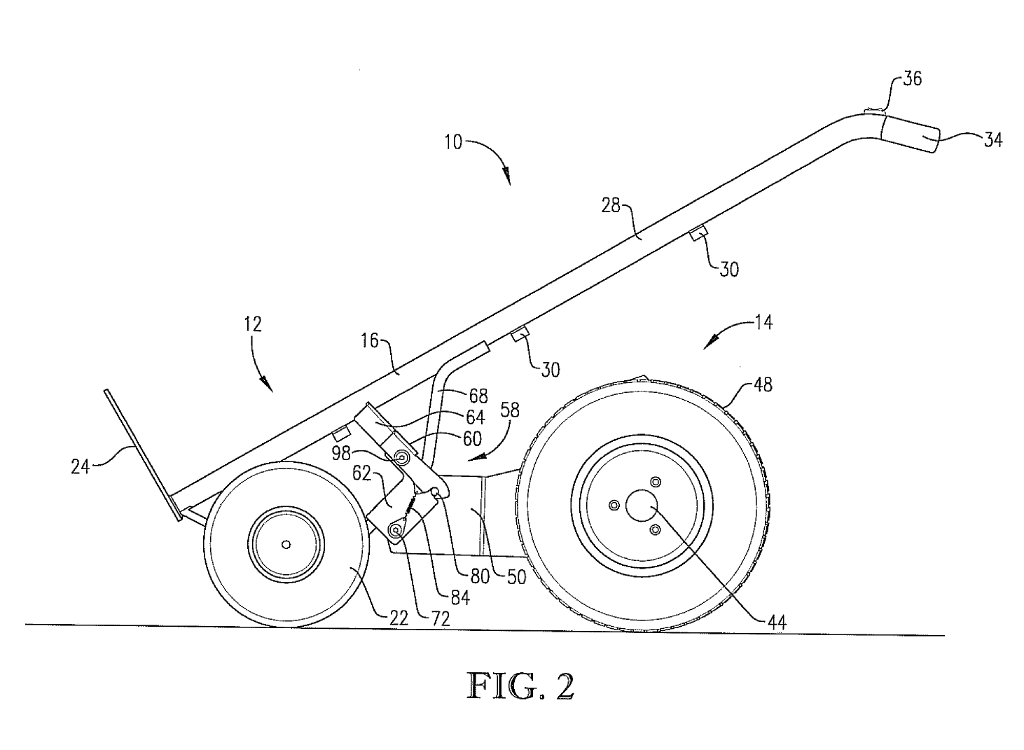

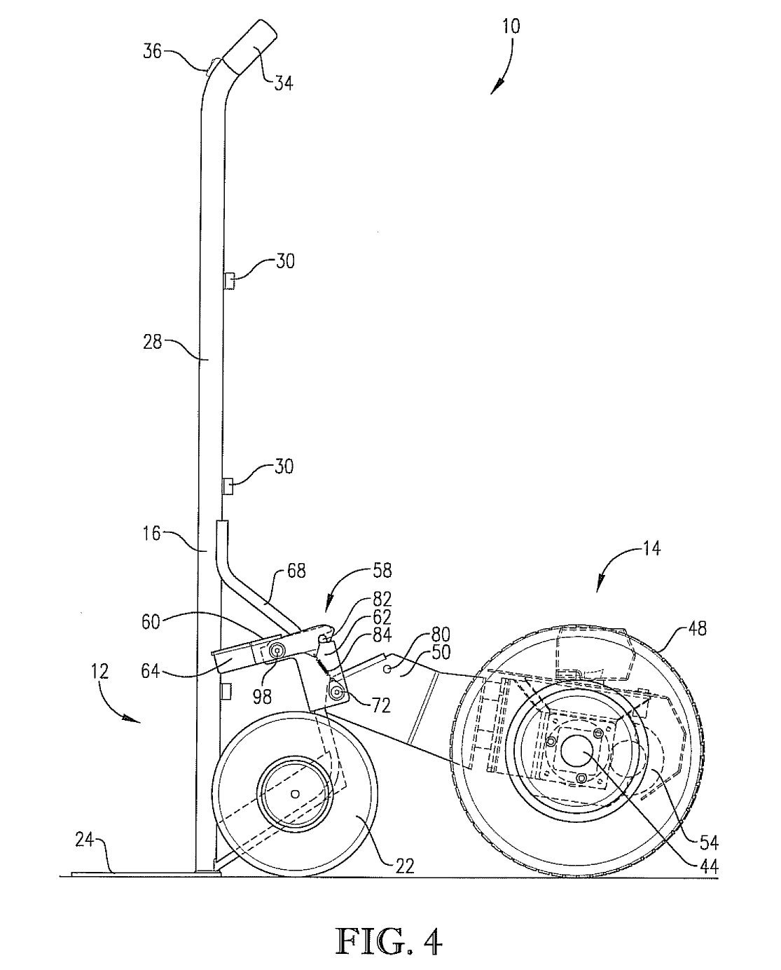

Turning to FIG. 2, load-bearing assembly 12 is shown in a reclined position with platform 24 raised out of contact with the ground. This is the configuration in which loads would normally be transported by hand truck 10. FIG. 4 depicts load-bearing assembly 12 in an upright position with platform 24 in contact with the ground. This is the configuration in which loads would normally be placed on or picked up by hand truck 10 and unloaded therefrom. Thus, load-bearing assembly 12, particularly load-bearing frame 16, is shiftable between an upright position and a reclined position relative to drive assembly 14.

Load-bearing assembly 12 includes a locking mechanism 58 for securing load-bearing frame 16 to drive assembly 14, particularly steering frame 50, when disposed in the reclined position. Locking mechanism 58 generally comprises a locking arm 60 that is pivotally attached to a coupler 62. Locking arm 60 presents a unique geometry which assists the user in operation thereof. The upper portion 64 of the locking arm is flared away from load-bearing frame 16 at an angle of approximately 30°. Flaring upper portion 64 in this manner allows locking arm 60 to be operated by the user's foot without interference from other portions of frames 16 and 50.

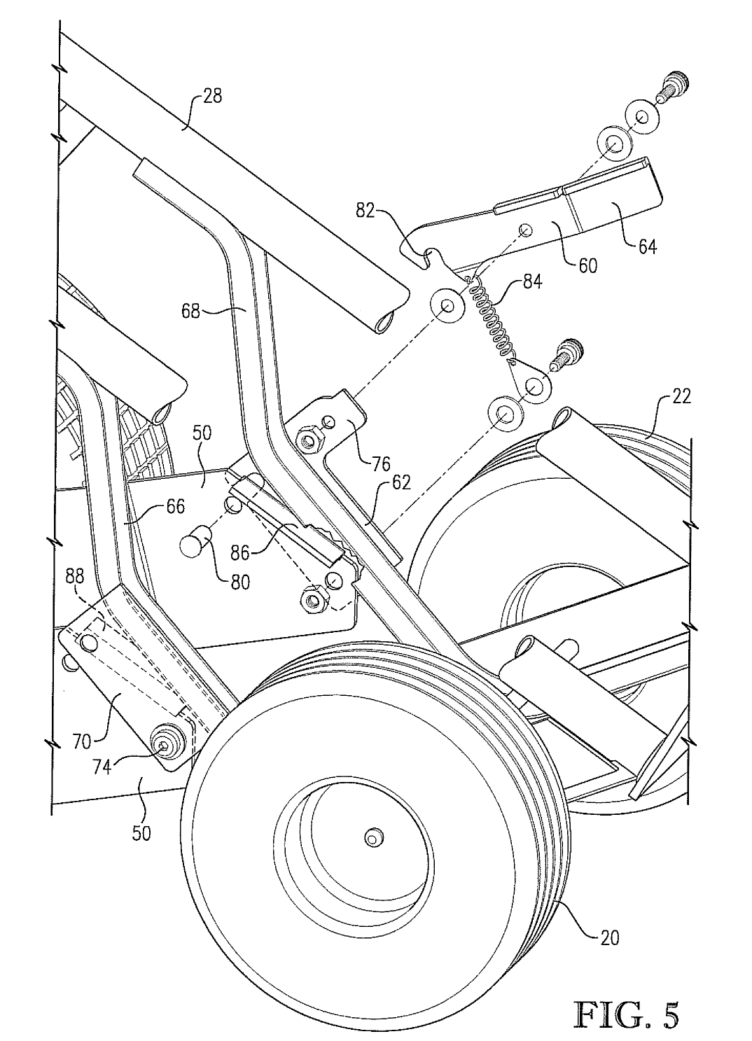

Load-bearing frame 16 further comprises a pair of support arms 66, 68 that are attached to support members 26, 28, respectively. Coupler 62 is affixed to support arm 68 and a coupler 70 is affixed to support arm 66 (see FIG. 5). Couplers 62, 70 are pivotally secured to steering frame 50 via a pair of forward pivot joints 72, 74, respectively. As shown, coupler 62 presents a different configuration from coupler 70. Most notably, coupler 62 presents an upper flange 76 to which locking arm 60 is pivotally secured and a notched section 78 for receiving a pin 80 secured to steering frame 50. The lower end of locking arm 60 presents a notch 82 (see FIG. 3a) configured to engage pin 80. When engaging pin 80, locking arm 60 secures load-bearing frame 16 to steering frame 50 thereby restricting the ability of load-bearing frame 16 to shift from the reclined position to the upright position. A biasing element 84, depicted in the figures as a spring, is attached to both locking arm 60 and coupler 62 and biases arm 60 toward engagement with pin 80.

As shown in FIG. 5, steering frame 50 presents a pair of shoulders 86, 88 which extend inwardly from the outer sidewalls thereof. When in the reclined position, support arms 66, 68 engage and rest upon shoulders 86, 88 thereby transferring a portion of the weight of the load to steering frame 50. Shoulders 86, 88 also operate as stops to prevent load-bearing frame 16 from reclining further should pin 80 fail.

Referring to FIGS. 3a, 3b, and 4, shifting of load-bearing frame 16 between the reclined position and the upright position begins by depressing upper arm portion 64 as illustrated by arrow A. Depressing upper arm portion 64 causes notch 82 to disengage pin 80 thereby permitting shifting of load-bearing frame 16 relative to drive assembly 14. As noted above, upper arm portion 64 is configured to be depressed by the user's foot so that the user may continue to keep both hands in contact with handles 32, 34.

While depressing upper arm portion 64, the user raises load-bearing frame 16 in the direction depicted by arrow B. Load-bearing assembly 12 pivots about pivot joints 72, 74 relative to drive assembly 14 during the shifting process. Once notch 82 is shifted forward of pin 80, the user may remove his foot from upper arm portion 64. While firmly grasping handles 32, 34 the user may continue to shift load-bearing frame 16 toward the upright position until platform 24 rests on the ground. At the same time, steering frame 50 shifts upwardly relative to the ground (as illustrated by arrow C) as wheels 20, 22 rotate toward drive assembly 14. This upward shifting is apparent in FIG. 4.

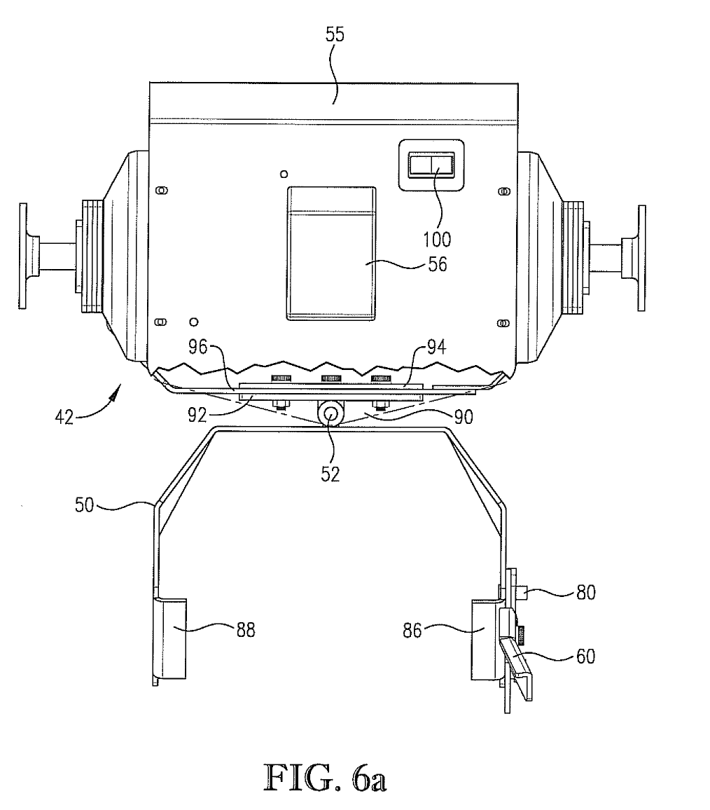

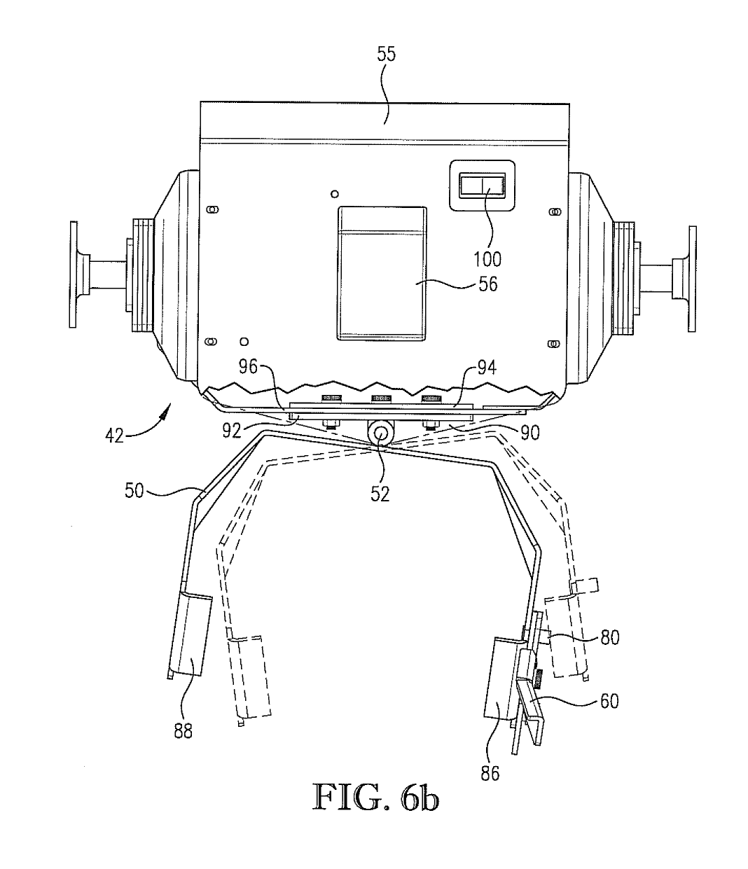

The shifting of steering frame 50 about rear pivot joint 52 is shown in FIGS. 6a and 6b. FIG. 6a depicts steering frame 50 in the configuration for movement of hand truck 10 in a straight line (i.e., frame 50 is not skewed to either side of motor assembly 42). FIG. 6b illustrates the ability of frame 50 to swing laterally during maneuvering of hand truck 10. Outer covering 55 presents a forward section 90 that extends toward steering frame 50 and covers rear pivot joint 52. Forward section 90 operates to restrict the range of motion of frame 50 about joint 52 so as to improve the safety of hand truck 10 by preventing any part of the operator's body from getting caught between motor assembly 42 and steering frame 50 during turning maneuvers. In certain embodiments, forward section 90 and frame 50 are configured to allow pivoting of frame 50 relative to motor assembly 42 of less than about 30° to either the right or left of center, with “center” being shown in FIG. 6a. In other embodiments, the range of pivot is less than about 20° to either the right or left of center. In still other embodiments, the range of pivot is less than about 15° to either the right or left of center.

Plates 92 and 94 are used to attach steering frame 50 to the forward face plate 96 of outer covering 55. Plates 92 and 94 are shown bolted to face plate 96. In certain embodiments, this attachment is configured so as to allow at least some relative shifting of face plate 96 relative to plates 92 and 94. This may be accomplished by providing larger holes (not shown) through face plate 96 than are provided in plates 92 and 94. This configuration allows for independent vertical shifting of rear axle 44 relative to forward axle 18 during transport of a load, particularly across uneven terrain.

Forward pivot joints 72, 74 and rear pivot joint 52 are located aft of forward axle 18 and forward of rear axle 44. By positioning the pivot joints in this manner, increased stability is achieved compared to other embodiments or devices in which one or more pivot joints are positioned even with the forward or rear axle or outside either axle.

The assembly of steering frame 50, locking mechanism 58, and load-bearing frame 16 is shown in FIG. 5. Couplers 62, 70 are attached to the outboard portions of support arms 68, 66, respectively. Steering frame 50 is attached to the inboard surfaces of couplers 62, 70 at forward pivot joints 72, 74. Locking arm 60 is pivotally attached to the outboard surface of upper flange 76 to permit selective rocking of arm 60 about a pivot joint 98. Thus, the outer margins of steering frame 50 are included within the margins presented by the inboard sidewalls of wheels 20, 22.

In certain embodiments, rear axle 44 presents a length that is greater than the length of forward axle 18. Thus, forward wheels 20, 22 are disposed entirely within the margins presented by the outboard sidewalls of drive wheels 46, 48. In certain embodiments, hand truck 10 presents a width of 32 inches or less thereby enabling it to pass through most standard doorways. Further, the diameter and width of drive wheels 46, 48 are greater than the diameter and width of forward wheels 20, 22. This configuration of wheel dimensions and axle length presents the least amount of interference with the loading and unloading of objects to be transported by hand truck 10 and the greatest stability for transporting such objects over a multitude of terrains, especially rugged surfaces.

In the operation of hand truck 10, the user first selects a motor speed setting using toggle switch 100 (see FIG. 6a). As shown, switch 100 is located on motor assembly 42, although this switch may be provided on one of user handles 32, 34 for convenience. In certain embodiments, switch 100 is provided with three settings: fast, slow, and a center “off” setting. Next, the user positions hand truck 10 in place behind the object to be transported. Load-bearing frame 16 is then shifted from the reclined position as shown in FIG. 2 to the upright position as shown in FIG. 4 by unlatching locking arm 60 from pin 80. The object to be transported may then be loaded onto platform 24.

Once the object is secured to load-bearing frame 16 using straps 38, 40, the user may grasp handles 32, 34 and shift load-bearing frame 16 to the reclined position for transport. Locking arm 60 may be configured to automatically latch onto pin 80 so that the user need not manually actuate arm 60 as is required to release arm 60 from pin 80. Alternatively, the user may choose to manually raise motor assembly 42 so that pin 80 locks into notch 82 of arm 60. The user may then kneel or stand on the back end of motor assembly 42 to assist in shifting load-bearing frame 16 to the reclined position with drive wheels 46, 48 in contact with the ground. This second mode of latching arm 60 with pin 80 is particularly useful in the transport of heavy objects that may be difficult to recline using only handles 32, 34.

Using switch 36, the user can selectively operate electric motor 54 to cause hand truck 10 to move in either a forward or reverse direction. Hand truck 10 may be configured so that its maximum speed in either direction is less than about 5 MPH, and more preferably less than about 2 MPH. The user then maneuvers hand truck 10 toward the final destination using handles 32, 34. Upon reaching the final destination, the user begins the unloading process by shifting load-bearing frame 16 to the upright position. Using his foot, the user actuates locking arm 60 while continuing to grasp handles 32, 34. The user then shifts the load-bearing frame into the upright position until platform 24 rests on the ground. Straps 38,40 may then be released and hand-truck 10 backed away from the object.

As discussed above, hand truck 10 allows heavy loads to be transported over many different types of terrain, particularly uneven or non-level surfaces with minimal physical exertion by the user. Hand truck 10 is capable of safely transporting loads of up to about 600 lbs. over rough outdoor terrain and inclines of up to about 30°.

I claim:

1. A motorized hand truck comprising:
a load-bearing assembly including
a load-bearing frame, and
a forward axle coupled to said load-bearing frame and presenting a pair of forward wheels, said forward wheels being attached to opposite ends of said forward axle; and
a drive assembly including
a motor assembly coupled to a rear axle, said rear axle presenting a pair of drive wheels, said drive wheels being attached to opposite ends of said rear axle, and
a steering frame that is pivotally coupled to said motor assembly, said steering frame pivoting relative to said motor assembly about a generally upright axis,
said steering frame also being pivotally coupled to said load-bearing assembly, said load bearing assembly pivoting relative to said steering frame about a generally horizontal axis.

2. The hand truck according to claim 1, wherein said pivot axes are located aft of said forward axle and forward of said rear axle.

3. The hand truck according to claim 1, wherein said motor assembly comprises an electric motor.

4. The hand truck according to claim 3, wherein said load-bearing frame presents at least one user handle including a switch for selectively controlling the operation of said electric motor.

5. The hand truck according to claim 1, wherein said load-bearing frame is shiftable between an upright position and a reclined position relative to said drive assembly.

6. The hand truck according to claim 5, wherein said steering frame further comprises a locking pin and said load-bearing assembly further comprises a locking arm configured for releasable engagement with said locking pin.

7. The hand truck according to claim 6, wherein said locking arm is pivotally secured to said load-bearing assembly and is shiftable between a locked position and an unlocked position.

8. The hand truck according to claim 7, wherein said locking arm engages said locking pin when said load-bearing frame is in the reclined position and is disengaged from said locking pin when said load-bearing frame is in the upright position.

9. The hand truck according to claim 6, wherein said load-bearing frame comprises a pair of spaced-apart support arms, each of said support arms presenting an outboard coupler that is pivotally secured to said steering frame.

10. The hand truck according to claim 9, wherein said lever arm is pivotally secured to one of said couplers and is disposed on the outboard side thereof opposite said support arm.

11. The hand truck according to claim 9, wherein said steering frame comprises a pair of shoulders that engage said support arms when said load-bearing frame is in the reclined position.

12. A motorized hand truck comprising:
a load-bearing assembly including
a load-bearing frame comprising at least one user handle presenting a switch for controlling the operation of said hand truck,
a locking arm, and
a forward axle coupled to said load-bearing frame and presenting a pair of forward wheels; and
a drive assembly including
an electric motor assembly coupled to a rear axle, said rear axle presenting a pair of drive wheels,
the operation of said motor assembly being controlled by said switch, and
a steering frame that is pivotally coupled to said motor assembly via a rear pivot joint and to said load-bearing assembly via a pair of forward pivot joints, said steering frame also including a locking pin, said locking arm configured for releasable engagement with said locking pin,
said load-bearing frame being shiftable between an upright position and a reclined position relative to said drive assembly,
said locking arm and said locking pin cooperating to lock said load-bearing frame in said reclined position.

13. The hand truck according to claim 12, wherein said rear pivot joint permits shifting of said steering frame relative to said motor assembly about a generally upright axis.

14. The hand truck according to claim 12, wherein said forward pivot joints permit shifting of said load-bearing assembly relative to said steering frame about a generally horizontal axis.

15. The hand truck according to claim 12, wherein said pivot joints are located aft of said forward axle and forward of said rear axle.

16. The hand truck according to claim 12, wherein said load-bearing frame comprises a pair of spaced-apart support arms and said steering frame comprises a pair of shoulders that engage said support arms when said load-bearing frame is in the reclined position.

17. The hand truck according to claim 16, wherein each of said support arms present an outboard coupler that is pivotally secured to said steering frame.

18. The hand truck according to claim 12, wherein said drive assembly including a battery pack for providing power to said electric motor assembly.

19. The hand truck according to claim 12, wherein said drive wheels present opposed outer drive wheel margins and wherein said forward wheels present opposed outer forward wheel margins, the distance between said outer drive wheel margins being greater than the distance between said forward wheel margins.
